(19) United States
(12) Patent Application Publication
(10) Pub. No.: US 2022/0103582 A1
(43) Pub. Date: Mar. 31, 2022

(54) SYSTEM AND METHOD FOR CYBERSECURITY

(71) Applicant: Patrick Kidney, New York, NY (US)

(72) Inventor: Patrick Kidney, New York, NY (US)

(21) Appl. No.: 17/391,975

(22) Filed: Aug. 2, 2021

Related U.S. Application Data
(60) Provisional application No. 63/059,499, filed on Jul. 31, 2020.

(51) Int. Cl. G06F 21/60

(52) U.S. Cl. CPC H04L 63/1425; H04L 63/1416

(57) ABSTRACT

A method for threat detection and automatic mitigated response to IP & DDOS born Cyber Security events and Threats. The Disclosed system can provide autonomous system numbers (ASNs) to prevent several network-born cyber threats. These ASN can be distributed to devices on a network along with IP addresses. Disclosed are an ASN record that can be incorporated into Global DNS Servers and systems and can store the IP Address and Private and Public ASN numbers. Also, the disclosed system and method can also provide anomaly detection techniques based on the ASN and Geolocation Proximity.

### CROSS-REFERENCE TO RELATED APPLICATIONS

This application claims priority to the U.S. provisional patent application Ser. No. 63/059,499 filed on Jul. 31, 2020, which is incorporated herein by reference in its entirety.

### FIELD OF INVENTION

The present invention generally relates to the field of cybersecurity, and more particularly, to a system and method for detecting and mitigates network originated threats, such as IP address spoofing and distributed denial of services attacks.

### BACKGROUND

Unauthorized access to a network in order to cause harm or steal information is referred to as a network attack. A network can be compromised in a number of ways and the hackers keep developing more sophisticated ways of harming a network or steal data. Denial of service attack (DoS) is a type of network attack that overwhelms network resources resulting in denying the services to legitimate users. Such services can include websites, Emails, banking, eCommerce, and like. DoS can be accomplished by flooding a targeted host or network with traffic until the target cannot respond or simply crashes, making the services inaccessible to legitimate users. A distributed denial-of-service (DDoS) attack refers to DoS when multiple machines target a single host. DDoS attackers often leverage the use of a botnet-a group of hijacked internet-connected devices to conduct large-scale attacks. These kinds of attacks exploit the features of TCP and HTTP protocols.

DoS attacks are difficult to control. A typical solution is to identify and block computers from which the attacks are executed. However, identifying such computers is difficult and often results in false positives i.e., blocking a computer of a legitimate user. The hackers generally hide their IP addresses by methods generally knows as IP spoofing. Ip spoofing refers to modifying the source address in an Internet Protocol (IP) packet to hide the identity of the sender. IP spoofing is used by DDoS attackers to hide their identities.

Thus, an urgent need is appreciated for a solution to detect and prevent networks attacks, such as DDoS.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to system and method for preventing network-based attacks including IP Address Spoofing, Threat Detection Prevention for Distributed Denial of Services Attacks, and Advanced persistent threats.

In one aspect, disclosed is a system and method for threat detection and automatic mitigated response to IP & DDoS born Cyber Security events and Threats. The disclosed system can provide autonomous system numbers (ASNs) to prevent several network-born cyber threats. These ASNs can be distributed to devices on a network along with IP addresses. Disclosed are an ASN record that can be incorporated into Global DNS Servers and systems and can store the IP Address and Private and Public ASN numbers. Also, the disclosed system and method can also provide anomaly detection techniques based on the ASN and Geolocation Proximity.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing an exemplary embodiment of the system, according to the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

In one aspect, disclosed is a cybersecurity system and a method for detecting and mitigating IP-spoofing-based network attacks including DDoS and DDoS Botnets. In addition to the IP addresses, a new namespace can be used, referred to herein as the autonomous system numbers (ASN). The ASNs are unique random numbers managed by a central main authority, such as Global Unified ASN Registry. The ASNs can be allocated to all computers in a network by Locally Sourced Registry that is in full sync with the Global Unified ASN Registry. The ASNs can be incorporated into existing network structures, such as DNS servers. A new record, referred to herein, as an ASN record can be generated which can be incorporated in central DNS servers. The ASN record can include an IP address, and a public and private ASN. This can be a new global DNS security standard that can be used to identify and mitigate the source of the attack.

In one embodiment, the ASN numbers can be allocated through an extension of the DHCP protocol which can allocate the IP addresses and also create an ASN record in the DNS having private and public ASN.

For detecting IP Spoofing-based attacks as well as DDOS and DDOS Botnets. The method can also provide for a threat detection algorithm. The threat detection algorithm can provide efficient network anomaly detection techniques with geolocation proximity. The geolocation proximity can be useful to detect the real source of the attack and capture Forensics data. The method can also provide for a machine learning-based model that upon detection of an anomaly, can do a reverse ASN lookup for traffic traversing a virtual appliance cluster.

In one embodiment, the machine learning-based model can be trained using live detection data generated from intrusion detection & prevention with automated responses and mitigation steps through active traffic redirection into native Honeypot containment. Honeypots are known in the art as decoy servers that act as a trap to identify attacks early and take the appropriate response.

Forensics can be collected via native Kubernetes with forensic security containers with an internal Blacklist that can sync with all internal devices.

The disclosed anomaly detection algorithm can quickly validate the sending ASN routing path and look for numbers that don't align in the ASN Record. It can use Geo-Location Proximity to detect the source of IP Spoofing, DDOS, and DDOS Botnet attacks. Every packet having the ASN sent through internet routing networks and goes through the cluster will automatically register in the Virtual Appliance registry when the traffic traverses the cluster. Once an anomaly is detected and the threat is identified, the connected source ASN can be validated then compared against the packet headers IP and as well as a new ASN Global DNS Record that contains both Private and Public ASNs. If the numbers that are registered do not match, then the connection is dropped immediately. All packets that have ASN that don't match the event get logged and then registered into the built-in Blacklist Registry of Detected Spoofed, and DDoS IPs. It will immediately drop a connection from the edge of the network if the IP Spoofer attempts to connect through another spoofed IP originating from the same ASN Number with a similar Address range and pattern of activity.

In one case, both attempts can be logged into a built-in Microsoft SQL 2019 Linux instance running within a container within the platform. The platform can have a 4 Node, Cross Connected Kubernetes Container Cluster, with Automated Response and Mitigation for Cyber Attacks. If a DDoS Attack, is attempted, the container cluster can start provisioning containers in a Honeypot Architecture that will have a very specific purpose for gathering forensic data. The initial attack is very briefly allowed once detected and will let it build to gather threat intel. Once the containers have the forensic data the system stores it in a Highly Encrypted Linux database Instance. The platform will keep a copy of some of the containers from the attack so that they can be uploaded to the Forensics Container Registry where they can be exported to provide to Governing authorities anywhere in the world. The source of the attacks can then be blacklisted including Public/Private ASN Numbers.

In one embodiment, the disclosed solution can be built on a container platform that will contain forensic containers that will log packets from the attack. If it is just a single source DDOS attack, one forensic container can be launched and capture all of the attacker's network locations. These containers can record and retain all the data on the attack and can be exportable to authorities so that they can arrest the associated cybercriminal. If it is a Botnet attack coming from dozens to 100′ of zombie machines, then a container can be provisioned for every source in the attack including Geo-location proximity and the Internet-facing network router that is the source of the attack. Their Public ASN can be identified allowing authorities to home in on the criminals.

In one embodiment, the ASN Record can be a unique DNS Record that can capture the server or endpoints IP Address local ASN, and the Public ASN on the internet-facing router and add to the ASN Record. Once adopted, every DNS Server on the planet can use the ASN Numbers for all networks born threat detection, prevention, and automated response to threats.

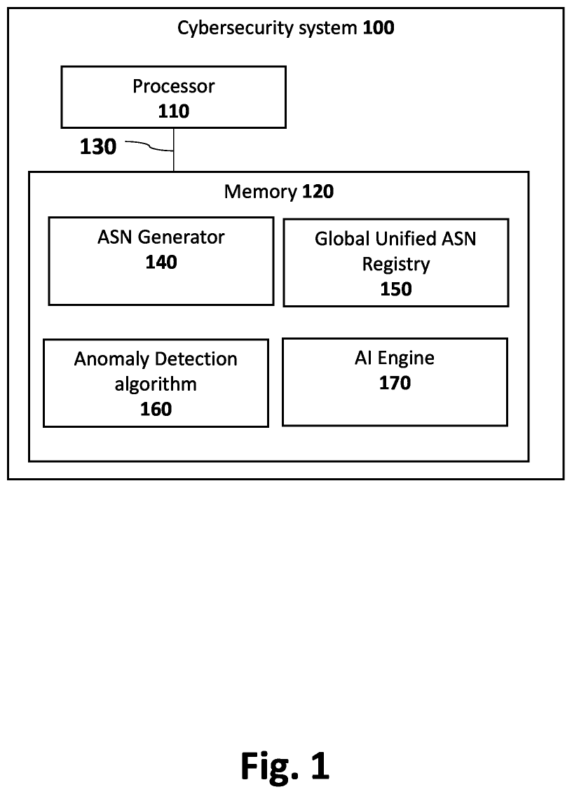

Referring to FIG. 1 which is a block diagram showing an exemplary embodiment of the system that can have a processor 110 and a memory 120 coupled to the processor through a system bus 130. The memory can include an ASN generator 140. The ASN generator upon execution by the processor can generate unique numbers for each device on a network. In one case, an extension of Dynamic Host Configuration Protocol can generate the ASNs. The ASN can be recorded in ASN records that include an IP address, a public and private ASN. The ASNs including the public and private ASNs can be stored in a centralized registry, as a Global Unified ASN Registry 150. In case, an anomaly is detected by the disclosed system, using the Anomaly detection algorithm 160, the AI engine 170 can find the source of the anomaly, such as a DoS attack. The AI engine can go for reverse ASN lookup to find the source of the anomaly.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for preventing network attacks, the method comprising the steps of:
generating, autonomous system numbers (ASNs) for devices on a network;
providing a global registry for recording autonomous system numbers as a public autonomous system number (ASN) and private ASN; and
providing an ASN record, the ASN records has an IP address, the public ASN, and the private ASN for a device.

2. The method according to claim 1, wherein the method further comprises the steps of:
applying, anomaly detecting algorithm, to detect an anomaly in a network; and
upon detecting the anomaly, applying machine learning-based algorithms to detect the source of the anomaly.
